(19) United States
(12) Patent Application Publication
(10) Pub. No.: US 2019/0047588 A1
(43) Pub. Date: Feb. 14, 2019

(54) DRIVER STATE RECOGNITION APPARATUS, DRIVER STATE RECOGNITION SYSTEM, AND DRIVER STATE RECOGNITION METHOD

(71) Applicant: OMRON Corporation, Kyoto-shi (JP)

(72) Inventors: Tomohiro YABUUCHI, Kyoto-shi (JP); Tomoyoshi AIZAWA, Kyoto-shi (JP); Tadashi HYUGA, Hirakata-shi (JP); Hatsumi AOI, Kyotanabe-shi (JP); Kazuyoshi OKAJI, Omihachiman-shi (JP); Hiroshi SUGAHARA, Kyoto-shi (JP); Michie UNO, Kyoto-shi (JP); Koji TAKIZAWA, Kyoto-shi (JP)

(73) Assignee: OMRON Corporation, Kyoto-shi (JP)

(21) Appl. No.: 16/038,367

(22) Filed: Jul. 18, 2018

(30) Foreign Application Priority Data
Aug. 10, 2017 (JP) 2017-155259

(51) Int. Cl. B60W 50/14; G05D 1/00; G06K 9/00

(52) U.S. Cl. CPC B60W 50/14; G05D 1/0088; B60W 2420/42; B60W 2050/143; B60W 2540/00; G06K 9/00845

(57) ABSTRACT

A driver state recognition apparatus that recognizes a state of a driver of a vehicle provided with an autonomous driving system includes a state recognition data acquisition unit that acquires state recognition data of an upper body of the driver, a shoulder detection unit that detects shoulders of the driver using the state recognition data acquired by the state recognition data acquisition unit, and a readiness determination unit that determines whether the driver is in a state of being able to immediately hold the steering wheel of the vehicle during autonomous driving, based on detection information from the shoulder detection unit.

### CROSS-REFERENCES TO RELATED APPLICATIONS

This application claims priority to Japanese Patent Application No. 2017-155259 filed Aug. 10, 2017, the entire contents of which are incorporated herein by reference.

### FIELD

The disclosure relates to a driver state recognition apparatus, a driver state recognition system, and a driver state recognition method, and more particularly to a driver state recognition apparatus, a driver state recognition system, and a driver state recognition method that recognize a state of a driver of a vehicle that can drive autonomously.

### BACKGROUND

In recent years, development of autonomous driving technologies for vehicles has been actively pursued. It is required for a driver of a vehicle in which an autonomous driving system is installed to monitor the autonomous driving system even during autonomous driving, so that if, for example, an abnormality or failure occurs in the autonomous driving system, the autonomous driving system reaches the operating limit, or the autonomous driving control ends, the driver can smoothly take over the driving operation.

For example, in the following JP 4333797, a technology is disclosed for detecting drowsiness information such as the line of sight of the driver and the degree of opening of the eyelids from an image of the driver captured by a camera installed in the vehicle, calculating an actual degree of concentration using the drowsiness information, and reducing the traveling speed controlled by auto-cruise control in a case where the actual degree of concentration is lower than a required degree of concentration, such as, for example, in a case where the driver's concentration decreases due to drowsiness.

As described above, if the driver dozes due to drowsiness during autonomous driving, the driver cannot monitor the autonomous driving system responsibly. As states in which the driver cannot monitor the autonomous driving system responsibly, various states other than the above-mentioned dozing state are conceivable. On the other hand, for determining whether the driver is monitoring the autonomous driving system responsibly, it is also important to recognize whether or not the driver is adopting a posture in which he or she is able to immediately take over the driving operation even during autonomous driving. However, in the monitoring method using the driver's drowsiness information disclosed in JP 4333797, there is a problem in that the posture of the driver cannot be appropriately recognized.

JP 4333797 is an example of background art.

### SUMMARY

One or more aspects have been made in view of the above-mentioned circumstances, and one or more aspects may provide a driver state recognition apparatus, a driver state recognition system, and a driver state recognition method that can accurately recognize a driver's posture so as to enable the driver to promptly take over a driving operation, particularly operation of a steering wheel, even during autonomous driving.

In order to achieve the above-mentioned object, a driver state recognition apparatus according to one or more aspects is a driver state recognition apparatus for recognizing a state of a driver in a vehicle provided with an autonomous driving system, the driver state recognition apparatus including:

a state recognition data acquisition unit configured to acquire state recognition data of an upper body of the driver;

a shoulder detection unit configured to detect a shoulder of the driver using the state recognition data acquired by the state recognition data acquisition unit; and

a readiness determination unit configured to determine, based on detection information from the shoulder detection unit, whether the driver is in a state of being able to immediately hold a steering wheel of the vehicle during autonomous driving.

In the case where the driver goes to hold the steering wheel of the vehicle in an appropriate posture, the shoulders of the driver and the steering wheel will be substantially facing each other. Accordingly, it is possible to determine whether the driver is in a state of being able to immediately hold the steering wheel, by recognizing the state of driver's shoulders.

According to the above driver state recognition apparatus, the shoulders of the driver are detected from the state recognition data of the upper body of the driver, and it is determined whether the driver is in the state of being able to immediately hold the steering wheel during autonomous driving based on the detection information of the shoulders, thus enabling the processing up to and including the above determination to be efficiently executed. Furthermore, it can be accurately recognized whether the driver is adopting a posture that enables the driver to promptly take over the operation of the steering wheel even during autonomous driving, and it is possible to appropriately provide support such that takeover of manual driving from autonomous driving, particularly takeover of the operation of the steering wheel, can be performed promptly and smoothly, even in cases such as where a failure occurs in the autonomous driving system during autonomous driving.

The state recognition data acquired by the state recognition data acquisition unit may be image data of the driver captured by a camera provided in the vehicle, or may be detection data of the driver detected by a sensor installed in the vehicle. By acquiring image data from the camera or detection data from the sensor as the state recognition data, it is possible to detect states such as the position and posture of the shoulders of the driver from the state recognition data.

Also, in the driver state recognition apparatus according to one or more aspects, the state of being able to immediately hold the steering wheel may be determined based on a predetermined normal driving posture.

According to the above driver state recognition apparatus, the state of being able to immediately hold the steering wheel is determined based on a predetermined normal driving posture, thus enabling the load of the determination processing performed by the readiness determination unit to be reduced and an accurate determination to be made.

In addition, in the driver state recognition apparatus according to one or more aspects, the readiness determination unit may include a distance estimation unit configured to estimate a distance between the shoulder of the driver and the steering wheel of the vehicle, based on the detection information from the shoulder detection unit, and may determine whether the driver is in the state of being able to immediately hold the steering wheel of the vehicle based on the distance estimated by the distance estimation unit.

According to the above driver state recognition apparatus, the distance between the shoulders of the driver and the steering wheel of the vehicle is estimated based on the detection information provided from the shoulder detection unit, and it is determined whether the driver is in a state of being able to immediately hold the steering wheel of the vehicle based on the estimated distance. Although the length of a human arm varies depending on sex, height and the like, individual differences from the median value are not so large. Accordingly, by determining whether the distance between the shoulders of the driver and the steering wheel is within a given range that takes into consideration individual differences in the length of the human arm and an appropriate posture for holding the steering wheel, for example, it is possible to precisely determine whether the driver is in the state of being able to immediately hold the steering wheel.

Also, in the driver state recognition apparatus according to one or more aspects, the state recognition data may include image data of the upper body of the driver captured by a camera provided in the vehicle, and the distance estimation unit may perform the estimation by calculating the distance based on a principle of triangulation, using information including a position of the shoulder of the driver in the image detected by the shoulder detection unit and a specification and a position and orientation of the camera.

According to the above driver state recognition apparatus, the distance between the shoulders of the driver and the steering wheel of the vehicle can be accurately estimated by calculation based on the principle of triangulation, thus enabling the determination accuracy by the readiness determination unit to be increased.

Also, in the driver state recognition apparatus according to one or more aspects, in a case where an origin provided on the steering wheel of the vehicle is at a vertex of a right angle of a right angle triangle whose hypotenuse is a line segment connecting the camera and the shoulder of the driver, the specification of the camera includes information of an angle of view a and a pixel number Width in a width direction of the camera, the position and orientation of the camera include information of an attachment angle θ of the camera and a distance D1 from the camera to the origin, and the position of the shoulder of the driver in the image is given as X, the distance estimation unit may calculate an angle φ formed by a line segment connecting the origin and the shoulder of the driver and the line segment connecting the camera and the shoulder of the driver with an equation 1: φ=θ+α/2−α×X/Width, and may perform the estimation by calculating a distance D between the shoulder of the driver and the steering wheel of the vehicle with an equation 2: D=D1/tan φ.

According to the above driver state recognition apparatus, the distance between the shoulder of the driver and the steering wheel of the vehicle can be accurately estimated by simple calculation processing, and the load on the determination processing by the readiness determination unit can be reduced.

In addition, in the driver state recognition apparatus according to one or more aspects, the readiness determination unit may estimate a position of the shoulder of the driver based on the detection information from the shoulder detection unit, and may determine whether the driver is in the state of being able to immediately hold the steering wheel of the vehicle based on the estimated position of the shoulder of the driver.

According to the above-mentioned driver state recognition apparatus, the position of the shoulders of the driver is estimated using the detection information from the shoulder detection unit, and it is determined whether the driver is in the state of being able to immediately hold the steering wheel of the vehicle based on the estimated position of the shoulders of the driver. In the case where the driver goes to hold the steering wheel of the vehicle in an appropriate posture, the driver will be in the state in which the driver substantially faces the steering wheel. Thus, in the state of being able to immediately hold the steering wheel, individual differences in the position of the shoulders of the driver are not so large. Therefore, by estimating the position of the shoulders of the driver and determining whether the estimated position of the shoulders satisfies a predetermined condition by, for example, determining whether the shoulders of the driver have been detected within a certain region in a region recognized by the state recognition data, it is possible to precisely determine whether the driver is in the state of being able to immediately hold the steering wheel.

Also, the driver state recognition apparatus according to one or more aspects may further include a notification processing unit configured to perform notification processing for prompting the driver to correct a posture, if the readiness determination unit determines that the driver in not in the state of being able to immediately hold the steering wheel of the vehicle.

According to the above driver state recognition apparatus, if it is determined that the driver in not in the state of being able to immediately hold the steering wheel of the vehicle, notification processing for prompting the driver to correct his or her posture is performed. In this manner, it is possible to swiftly prompt the driver to correct his or her posture such that the driver keeps a posture that enables the driver to immediately hold the steering wheel even during autonomous driving.

Also, the driver state recognition apparatus according to one or more aspects may further include an information acquisition unit configured to acquire information arising during autonomous driving from the autonomous driving system, and the notification processing unit may perform the notification processing for prompting the driver to correct the posture according to the information arising during autonomous driving that is acquired by the information acquisition unit.

According to the above-mentioned driver state recognition apparatus, the notification processing for prompting the driver to correct his or her posture is performed according to the information arising during autonomous driving that is acquired by the information acquisition unit. In this manner, it is not required to needlessly perform various notifications to the driver, according to the situation of the autonomous driving system, thus enabling power and processing required for notification to be reduced.

In addition, in the driver state recognition apparatus according to one or more aspects, the information arising during autonomous driving may include at least one of monitoring information of surroundings of the vehicle and takeover request information for taking over manual driving from autonomous driving.

According to the above driver state recognition apparatus, if the monitoring information of the vehicle surroundings is included in the information arising during autonomous driving, notification for prompting the driver to correct his or her posture can be performed according to the monitoring information of the vehicle surroundings. Also, if the takeover request information for taking over manual driving from autonomous driving is included in the information arising during autonomous driving, notification for prompting the driver to correct his or her posture can be performed according to the takeover request information for taking over manual driving from autonomous driving.

A driver state recognition system according to one or more aspects may include any of the above driver state recognition apparatuses and a state recognition unit configured to output the state recognition data to the driver state recognition apparatus.

According to the above driver state recognition system, the system is configured by the driver state recognition apparatus and a state recognition unit configured to output the state recognition data to the driver state recognition apparatus. In this configuration, it is possible to construct a system that is able to appropriately recognize whether the driver is adopting a posture in which the driver can quickly take over the operation of the steering wheel even during autonomous driving, and is able to appropriately provide support such that takeover of manual driving from autonomous driving can be performed promptly and smoothly, even in cases such as where a failure occurs in the autonomous driving system during autonomous driving. Note that the state recognition unit may be a camera that captures image data of the driver acquired by the state recognition data acquisition unit, a sensor that detects detection data of the driver acquired by the state recognition data acquisition unit, or a combination thereof.

Also, a driver state recognition method according to one or more aspects is a driver state recognition method for recognizing a driver state of a vehicle provided with an autonomous driving system, the driver state recognition method including:

a step of acquiring state recognition data of an upper body of the driver from a state recognition unit configured to recognizes a state of the driver;

a step of storing the acquired state recognition data in a state recognition data storage unit;

a step of reading out the state recognition data from the state recognition data storage unit;

a step of detecting a shoulder of the driver using the read state recognition data; and

a step of determining, based on detection information of the detected shoulder of the driver, whether the driver is in a state of being able to immediately hold a steering wheel of the vehicle during autonomous driving.

According to the above-mentioned driver state recognition method, the shoulders of the driver are detected from the state recognition data of the upper body of the driver, and it is determined whether the driver is in the state of being able to immediately hold the steering wheel during autonomous driving based on the detection information of the shoulders, thus enabling the processing up to and including the above determination to be efficiently executed. Furthermore, it can be accurately recognized whether the driver is adopting a posture that enables the driver to promptly take over the operation of the steering wheel even during autonomous driving, and it is possible to appropriately provide support such that takeover of manual driving from autonomous driving, particularly takeover of the operation of the steering wheel, can be performed promptly and smoothly, even in cases such as where a failure occurs in the autonomous driving system during autonomous driving.

### BRIEF DESCRIPTION OF THE DRAWINGS

FIG. 1 is a block diagram illustrating an example of a configuration of a relevant section of an autonomous driving system that includes a driver state recognition apparatus according to an embodiment 1.

FIG. 2 is a side view illustrating a region a vicinity of a driver's seat of a vehicle in which a driver state recognition system according to an embodiment 1 is installed.

FIG. 3 is a block diagram illustrating an example of a hardware configuration of a driver state recognition apparatus according to an embodiment 1.

FIGS. 4A and 4B are diagrams illustrating an example of a distance estimation processing method performed by a control unit in a driver state recognition apparatus according to an embodiment 1.

FIG. 4A is a plan view illustrating the inside of a vehicle.

FIG. 4B is a diagram illustrating an example of captured image data.

FIG. 5 is a flowchart illustrating a processing operation performed by a control unit in a driver state recognition apparatus according to an embodiment 1.

FIG. 6 is a block diagram illustrating an example of a hardware configuration of a driver state recognition apparatus according to an embodiment 2.

FIG. 7 is a diagram illustrating an example of shoulder position determination region data stored in a storage unit of a driver state recognition apparatus according to an embodiment 2.

FIG. 8 is a flowchart illustrating a processing operation performed by a control unit in a driver state recognition apparatus according to an embodiment 2.

### DETAILED DESCRIPTION

Hereinafter, embodiments of a driver state recognition apparatus, a driver state recognition system, and a driver state recognition method will be described based on the drawings. Note that the following embodiments are specific examples of the present invention and various technical limitations are applied, but the scope of the present invention is not limited to these embodiments unless particularly stated in the following description.

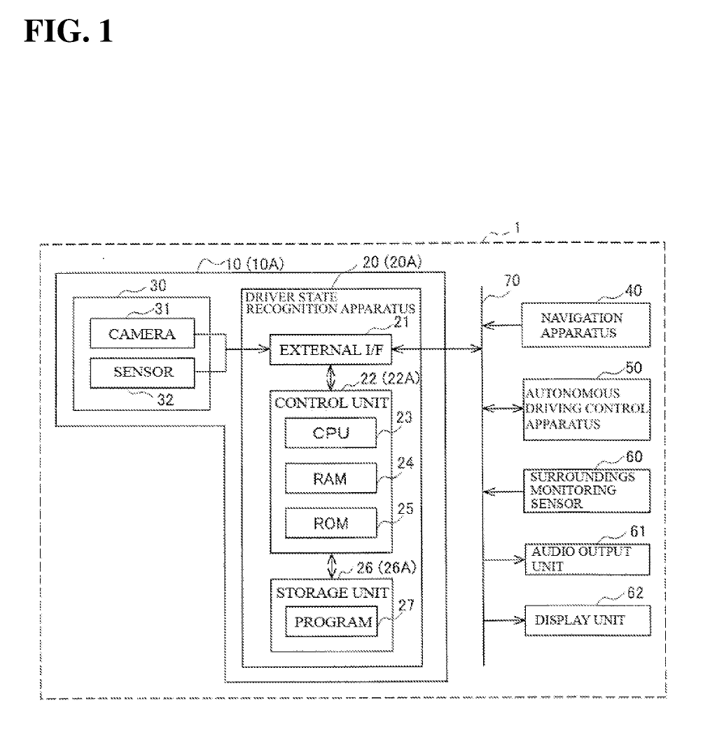

FIG. 1 is a block diagram showing an example of a configuration of a relevant section of an autonomous driving system 1 that includes a driver state recognition apparatus 20 according to an embodiment 1.

The autonomous driving system is configured to include a driver state recognition apparatus 20, a state recognition unit 30, a navigation apparatus 40, an autonomous driving control apparatus 50, a surroundings monitoring sensor 60, an audio output unit 61, and a display unit 62, and these units are connected via a bus line 70.

The autonomous driving system 1 includes an autonomous driving mode in which the system, as the agent, autonomously performs at least a part of travel control including acceleration, steering, and braking of a vehicle and a manual driving mode in which a driver performs driving operation, and the system is configured such that these modes can be switched.

In the autonomous driving mode in an embodiment, a mode is envisioned in which the autonomous driving system 1 autonomously performs all of acceleration, steering, and braking and the driver copes with requests when received from the autonomous driving system 1 (automation level equivalent to so-called level 3 or greater), but the application of an embodiment is not limited to this automation level. Also, times at which the autonomous driving system 1 requests takeover of manual driving during autonomous driving include, for example, at a time of the occurrence of a system abnormality or failure, at a time of the functional limit of the system, and at a time of the end of an autonomous driving zone.

The driver state recognition apparatus 20 is an apparatus for recognizing a state of a driver of a vehicle including the autonomous driving system 1, and is an apparatus for providing support, by recognizing the state of the shoulders of the driver and determining whether the driver is in a state of being able to immediately hold the steering wheel even during the autonomous driving mode, such that the driver can immediately take over the manual driving, particularly take over the operation of the steering wheel, if a takeover request for taking over manual driving is generated from the autonomous driving system 1.

The driver state recognition apparatus 20 is configured to include an external interface (external I/F) 21, a control unit 22, and a storage unit 26. The control unit 22 is configured to include a Central Processing Unit (CPU) 23, a Random Access Memory (RAM) 24, and a Read Only Memory (ROM) 25.

The storage unit 26 is configured to include a storage apparatus that stores data with a semiconductor device such as a flash memory, a hard disk drive, a solid-state drive, or other non-volatile memory or volatile memory. The storage unit 26 stores a program 27 to be executed by the driver state recognition apparatus 20 and the like. Note that part or all of the program 27 may be stored in the ROM 25 of the control unit 22 or the like.

The state recognition unit 30 for recognizing the state of the driver is configured to include a camera 31 that captures the driver who is sitting in a driver's seat. The camera 31 is configured to include a lens unit, an image sensor unit, a light irradiation unit, an input/output unit and a control unit for controlling these units, which are not shown. The image sensor unit is configured to include an image sensor such as a CCD or CMOS sensor, filters, and microlenses. The light irradiation unit includes a light emitting element such as an LED, and may be an infrared LED or the like so as to be able to capture images of the state of the driver both day and night. The control unit is configured to include a CPU, a RAM, and a ROM, for example, and may be configured to include an image processing circuit. The control unit controls the image sensor unit and the light irradiation unit to irradiate light (e.g. near infrared light etc.) from the light irradiation unit, and performs control for capturing an image of reflected light of the irradiated light using the image sensor unit.

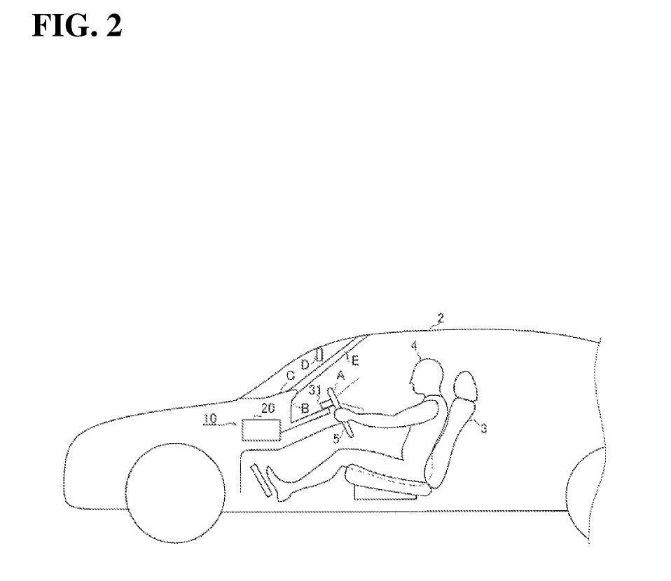

FIG. 2 is a side view showing a vicinity of the driver's seat of a vehicle 2 in which the driver state recognition system 10 according to an embodiment 1 is installed.

An attachment position of the camera 31 is not particularly limited, as long as it is a position at which the upper body (at least the portion of the face and shoulders) of a driver 4 who is sitting in a driver's seat 3 can be captured. For example, the attachment position may be a column portion of a steering wheel 5 as shown in FIG. 2. Alternatively, as another attachment position, the camera 31 may be installed in a steering wheel inner portion A, in a meter panel portion B, on a dashboard C, at a position near a rear-view mirror D, on an A pillar portion, or in the navigation apparatus 40, for example.

The number of cameras 31 may be one, or may also be two or more. The camera 31 may be configured separately (i.e. configured as a separate body) from the driver state recognition apparatus 20, or may be integrally configured (i.e. configured as an integrated body) with the driver state recognition apparatus 20. The type of camera 31 is not particularly limited, and the camera 31 may be a monocular camera, a monocular 3D camera, or a stereo camera, for example.

Also, as the state recognition unit 30, a sensor 32 such as a Time of Flight (TOF) sensor or a Kinect (registered trademark) sensor using a TOF method may be used with or instead of the camera 31. These different types of cameras and sensors may be used in combination. Image data captured by the camera 31 and detection data detected by the sensor 32 are sent to the driver state recognition apparatus 20. The driver state recognition system 10 is configured to include the driver state recognition apparatus 20, and the camera 31 and/or the sensor 32 serving as the state recognition unit 30.

The monocular 3D camera includes a distance measurement image chip as an image sensor, and is configured so as to be capable of recognizing, for example, the presence/absence, size, position, and posture of an object to be monitored.

Also, the TOF sensor or the Kinect (registered trademark) sensor is configured to include, for example, a light emitting portion that emits an optical pulse, a light detection portion that detects reflected light from the target object of the optical pulse, a distance measurement unit that performs distance measurement to the target object by measuring a phase difference of the reflected light, and a distance image generating unit (all of which are not shown). A near infrared LED or the like can be employed as the light emitting portion, and a CMOS image sensor or the like for capturing a distance image can be employed as the light detection portion. If the TOF sensor or the Kinect (registered trademark) sensor is employed, it is possible to detect the driver to be monitored and to measure the distance to the driver.

The navigation apparatus 40 shown in FIG. 1 is an apparatus for provide the driver with information such as a current position of the vehicle and a traveling route from the current position to a destination, and is configured to include a control unit, a display unit, an audio output unit, an operation unit, a map data storage unit, and the like (not shown). Also, the navigation apparatus 40 is configured to be capable of acquiring a signal from a GPS receiver, a gyro sensor, a vehicle speed sensor, and the like (not shown).

Based on the vehicle position information measured by the GPS receiver and the map information of the map data storage unit, the navigation apparatus 40 deducts information such as the road or traffic lane on which the own vehicle is traveling and displays the current position on the display unit. In addition, the navigation apparatus 40 calculates a route from the current position of the vehicle to the destination and the like, displays the route information and the like on the display unit, and performs audio output of a route guide and the like from the audio output unit.

Also, some types of information such as vehicle position information, information of the road on which the vehicle is traveling, and scheduled traveling route information that are calculated by the navigation apparatus 40 are output to the autonomous driving control apparatus 50. The scheduled traveling route information may include information related to switching control between autonomous driving and manual driving, such as information of start and end points of autonomous driving zones and information of zones for taking over manual driving from autonomous driving.

The autonomous driving control apparatus 50 is an apparatus for executing various kinds of control related to autonomous driving of the vehicle, and is configured by an electronic control unit including a control unit, a storage unit, an input/output unit and the like (not shown). The autonomous driving control apparatus 50 is also connected to a steering control apparatus, a power source control apparatus, a braking control apparatus, a steering sensor, an accelerator pedal sensor, a brake pedal sensor, and the like (not shown). These control apparatuses and sensors may be included in the configuration of the autonomous driving system 1.

Based on information acquired from each unit included in the autonomous driving system 1, the autonomous driving control apparatus 50 outputs a control signal for performing autonomous driving to each of the control apparatuses, performs autonomous traveling control of the vehicle (autonomous steering control, autonomous speed adjusting control, automatic braking control and the like), and also performs switching control for switching between autonomous driving mode and manual driving mode.

“Autonomous driving” refers to allowing the vehicle to autonomously travel along a road under control performed by the autonomous driving control apparatus 50 without the driver in the driver's seat performing a driving operation. For example, a driving state in which the vehicle is allowed to autonomously drive in accordance with a predetermined route to the destination and a traveling route that was automatically created based on circumstances outside of the vehicle and map information is included as autonomous driving. Then, if a predetermined cancellation condition of autonomous driving has been satisfied, the autonomous driving control apparatus 50 may end (cancel) autonomous driving. For example, in the case where the autonomous driving control apparatus 50 determines that the vehicle that is autonomously driving has arrived at a predetermined end point of an autonomous driving, the autonomous driving control apparatus 50 may perform control for ending autonomous driving. Also, if the driver performs autonomous driving cancel operation (for example, operation of an autonomous driving release button, or operation of the steering wheel, acceleration, or braking or the like performed by the driver), the autonomous driving control apparatus 50 may perform control for ending autonomous driving. “Manual driving” refers to driving in which the driver drives the vehicle as the agent that performs the driving operation.

The surroundings monitoring sensor 60 is a sensor that detects target objects that exist around the vehicle. The target objects may include road markings (such as a white line), a safety fence, a highway median, and other structures that affect travelling of the vehicle and the like in addition to moving objects such as vehicles, bicycles, and people. The surroundings monitoring sensor 60 includes at least one of a forward-monitoring camera, a backward-monitoring camera, a radar, LIDER (that is, Light Detection and Ranging or Laser Imaging Detection and Ranging) and an ultrasonic sensor. Detection data of the target object detected by the surroundings monitoring sensor 60 is output to the autonomous driving control apparatus 50 and the like. As the forward-monitoring camera and the backward-monitoring camera, a stereo camera, a monocular camera or the like can be employed. The radar transmits radio waves such as millimeter waves to the surroundings of the vehicle, and detects, for example, positions, directions, and distances of the target objects by receiving radio waves reflected by the target objects that exist in the surroundings of the vehicle. LIDER involves transmitting laser light to the surroundings of the vehicle and detecting, for example, positions, directions and distances of the target objects by receiving light reflected by the target objects that exist in the surroundings of the vehicle.

The audio output unit 61 is an apparatus that outputs various kinds of notifications based on instructions provided from the driver state recognition apparatus 20 with sound and voice, and is configured to include a speaker and the like.

The display unit 62 is an apparatus that displays various kinds of notification and guidance based on an instruction provided from the driver state recognition apparatus 20 with characters and graphics or by lighting and flashing a lamp or the like, and is configured to include various kinds of displays and indication lamps.

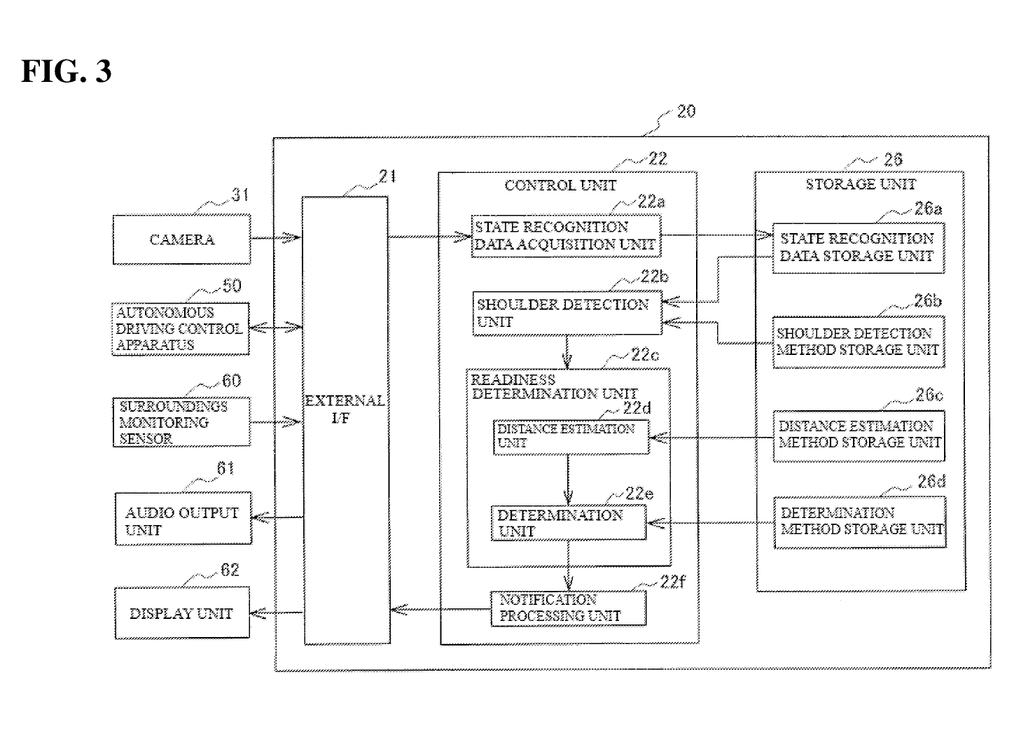

FIG. 3 is a block diagram showing an example of a hardware configuration of the driver state recognition apparatus 20 according to an embodiment 1.

The driver state recognition apparatus 20 is configured to include the external interface (external I/F) 21, the control unit 22, and the storage unit 26. The external I/F 21 is connected to, in addition to the camera 31, each unit of the autonomous driving system 1 such as the autonomous driving control apparatus 50, the surroundings monitoring sensor 60, the audio output unit 61, the display unit 62, and is configured by an interface circuit and a connecting connector for transmitting and receiving a signal to and from each of these units.

The control unit 22 is configured to include a state recognition data acquisition unit 22a, a shoulder detection unit 22b, and a readiness determination unit 22c, and may be configured to further include a notification processing unit 22f. The storage unit 26 is configured to include a state recognition data storage unit 26a, a shoulder detection method storage unit 26b, a distance estimation method storage unit 26c, and a determination method storage unit 26d.

The state recognition data storage unit 26a stores image data of the camera 31 acquired by the state recognition data acquisition unit 22a. Also, the state recognition data storage unit 26a may be configured to store the detection data of the sensor 32.

The shoulder detection method storage unit 26b stores, for example, a shoulder detection program executed by the shoulder detection unit 22b of the control unit 22 and data necessary for executing the program.

The distance estimation method storage unit 26c stores, for example, a distance estimation program, which is executed by the distance estimation unit 22d of the control unit 22, for calculating and estimating the distance between the shoulders of the driver and the steering wheel of the vehicle and data necessary for executing the program.

The determination method storage unit 26d stores, for example, a determination program, which is executed by the determination unit 22e of the control unit 22, for determining whether the driver is in the state of being able to immediately hold the steering wheel and data necessary for executing the program. For example, the determination method storage unit 26d may store range data of the estimated distances for determining whether the driver is in a state of being able to immediately hold the steering wheel with respect to the distances estimated by the distance estimation unit 22d. Also, the state in which the driver can immediately hold the steering wheel can be determined based on a predetermined normal driving posture, and these types of predetermined information may be stored in the determination method storage unit 26d. Note that the normal driving posture includes, for example, a posture in which the driver is holding the steering wheel with both hands.

The control unit 22 is an apparatus that realizes functions of the state recognition data acquisition unit 22a, the shoulder detection unit 22b, the readiness determination unit 22c, the distance estimation unit 22d, the determination unit 22e, and the notification processing unit 22f, by performing, in cooperation with the storage unit 26, processing for storing various data in the storage unit 26, and by reading out various kinds of data and programs stored in the storage unit 26 and causing the CPU 23 to execute those programs.

The state recognition data acquisition unit 22a constituting the control unit 22 performs processing for acquiring an image captured by the camera 31 and performs processing for storing the acquired image in the state recognition data storage unit 26a. The image of the driver may be a still image, or may be a moving image. For example, the images of the driver may be acquired at a predetermined interval after activation of the driver state recognition apparatus 20. Also, the state recognition data acquisition unit 22a may be configured to acquire the detection data of the sensor 32 and store the detection data in the state recognition data storage unit 26a.

The shoulder detection unit 22b reads out the image data from the state recognition data storage unit 26a, performs predetermined image processing on the image data based on the program that was read out from the shoulder detection method storage unit 26b, and performs processing for detecting the shoulders of the driver in the image.

In the processing performed by the shoulder detection unit 22b, various kinds of image processing for detecting the shoulders of the driver by processing the image data can be employed. For example, a template matching method may be used that involves storing in advance template images of the driver sitting in the driver's seat, comparing and collating these template images and the image captured by the camera 31, and detecting the position of the shoulders of the driver by extracting the driver from the captured image. Also, a background difference method may be used that involves storing in advance a background image in which the driver is not sitting in the driver's seat, and detecting the position of the shoulders of the driver by extracting the driver from the difference between that background image and the image captured by the camera 31. Furthermore, a semantic segmentation method may be used that involves storing in advance a model of an image of the driver sitting in the driver's seat obtained though machine learning by a learning machine, labeling the significance of each pixel in the image captured by the camera 31 using the learned model, and detecting the shoulder positions of the driver by recognizing a region of the driver. If a monocular 3D camera is used for the camera 31, the position of the shoulders of the driver may be detected using acquired information such as a detected position of each part or posture of the driver detected by the monocular 3D camera.

The readiness determination unit 22c includes the distance estimation unit 22d and the determination unit 22e.

Following the processing by the shoulder detection unit 22b, the distance estimation unit 22d preforms processing for estimating the distance between the shoulders of the driver and the steering wheel of the vehicle, based on the detection information of the shoulder detection unit 22b.

For the distance estimation processing performed by the distance estimation unit 22d, processing for estimating the distance between the steering wheel and the shoulders of the driver through a calculation performed based on the principle of triangulation may be used, by using information of the driver's shoulder positions in the image detected by the shoulder detection unit 22b, information such as a specification and the attachment position and orientation and the like of the camera 31, information on the distance between the camera 31 and the steering wheel, and the like. By using the TOF sensor or the Kinect (registered trademark) sensor for the sensor 32, processing for estimating the distances between the shoulders of the driver and the steering wheel of the vehicle may be performed using distance measurement data or the like acquired from the sensor 32.

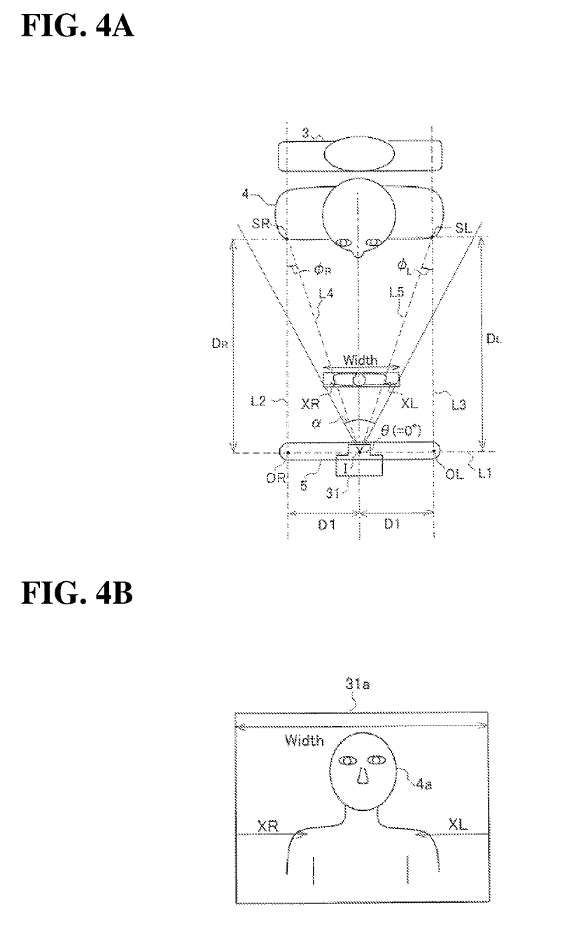

FIGS. 4A and 4B are diagrams showing an example of a method for estimating the distance between the shoulders of the driver and the steering wheel of the vehicle performed by the distance estimation unit 22d. FIG. 4A is a plan view of the inside of the vehicle. FIG. 4B is a diagram showing an example of image data captured by the camera.

FIG. 4A shows a state in which the driver 4 is sitting in the driver's seat 3. The steering wheel 5 is installed in front of the driver's seat 3. The position of the driver's seat 3 can be adjusted in the front-rear direction. The camera 31 is installed in the column portion of the steering wheel 5, and can capture the upper body of the driver 4 including the face (the portion from the chest up). Note that the attachment position and orientation of the camera 31 are not limited to this configuration.

In the example shown in FIG. 4A, viewed from the driver's seat 3 side, a right edge of the steering wheel is given as an origin OR, a left edge of the steering wheel 5 is given as an origin OL, a line segment connecting the origin OR and the origin OL is given as L1, a line segment passing through the origin OR and orthogonal to the line segment L1 is given as L2, a line segment passing through the origin OL and orthogonal to the line segment L1 is given as L3, an attachment angle θ of the camera 31 with respect to the line segment Li is set to 0° in this case, and distances between a center I of the image capturing surface of the camera 31 and each of the origins OR and OL are given as D1 (equidistant).

It is assumed that a right shoulder SR of the driver 4 is on the line segment L2 and a left shoulder SL of the driver 4 is on the line segment L3. The origin OR is the vertex of the right angle of a right angle triangle whose hypotenuse is a line segment L4 connecting the camera 31 and the right shoulder SR of the driver 4. In the same way, the origin OL is the vertex of the right angle of a right angle triangle whose hypotenuse is a line segment L5 connecting the camera 31 and the left shoulder SL of the driver 4.

Also, the angle of view of the camera 31 is shown by a and the pixel number in a width direction of an image 31 a is shown by Width. In the image 31a, the right shoulder position (pixel number in the width direction) of a driver 4a is shown by XR, and the left shoulder position (pixel number in the width direction) of the driver 4a is shown by XL.

The shoulder detection unit 22b detects the shoulder positions XR and XL of the driver 4a in the image 31a captured by the camera 31. If the shoulder positions XR and XL of the driver 4a in the image 31a can be detected, using known information, that is, using information related to the specification of the camera 31 (the angle of view a, pixel number Width in the width direction) and the position and orientation of the camera 31 (the angle θ with respect to the line segment L1 and the distances D1 from the origins OR and OL), an angle φ_{R} (an angle formed by the line segment L4 and the line segment L2) is acquired with an equation 1 shown below, and an angle φ_{L} (an angle formed by the line segment L5 and the line segment L3) is acquired with an equation 2 shown below. Note that in a case where lens distortion or the like of the camera 31 is strictly taken into consideration, calibration using internal parameters may be performed.

$$\begin{matrix}{ϕ}_{R} = 90 ° - ( ( 90 ° - θ ) - α / 2 + α \times XR / Width ) = θ + α / 2 - α \times XR / Width & Equation 1 \\ {ϕ}_{L} = 90 ° - ( ( 90 ° - θ ) - α / 2 + α \times XL / Width ) = θ + α / 2 - α \times XL / Width & Equation 2\end{matrix}$$

Note that the angle θ with respect to the line segment L1 of the camera 31 shown in FIG. 4A is 0°.

If the angle φ_{R} can be obtained, a triangle formed by connecting the origin OR, the center I of the image capturing surface, the right shoulder position SR is a triangle whose vertex of the right angle is the origin OR, and thus, by using the distance D1 from the origin OR to the center I of the image capturing surface and the angle φ_{R} that are known, it is possible to estimate a distance D_{R} from the right shoulder SR of the driver 4 to the origin OR (the steering wheel 5) through an equation 3 shown below.

In the same way, if the angle φ_{L} can be obtained, a triangle formed by connecting the origin OL, the center I of the image capturing surface, the left shoulder position SL is a triangle whose vertex of the right angle is the origin OL, and thus, by using the distance D1 from the origin OL to the center I of the image capturing surface and the angle φ_{L} that are known, it is possible to estimate a distance D_{L} from the left shoulder SL of the driver 4 to the origin OL (the steering wheel 5) through an equation 4 shown below.

D_{R}=D1/tan φ_{R} Equation 3:

(where φ_{R}=θ+α/2−α×XR/Width)

(assuming that: θ+α/2>α×XR/Width)

D_{L}=D1/tan φ_{L} Equation 4:

(where φ_{L}=θ+α/2−α×XL/Width)

(assuming that: θ+α/2>α×XL/Width)

Following the processing in the distance estimation unit 22d, the determination unit 22e performs processing for determining whether the distances that were estimated by the distance estimation unit 22d (for example, the distances D_{R} and D_{L} described in FIG. 4) are within a predetermined range. The predetermined range is set with consideration for the distance at which the driver can immediately hold the steering wheel. Also, the distance that the driver can immediately hold the steering wheel may be set based on the predetermined normal driving posture.

If it is determined by the readiness determination unit 22c that the driver is not in the state of being able to immediately hold the steering wheel, the notification processing unit 22f performs notification processing for prompting the driver to correct his or her posture. For example, the notification processing unit 22f performs processing for causing the audio output unit 61 and the display unit 62 to perform audio output processing and display output processing for prompting the driver to adopt a posture in which the driver can immediately hold the steering wheel. Also, the notification processing unit 22f may output a signal notifying to continue autonomous driving rather than cancel autonomous driving to the autonomous driving control apparatus 50.

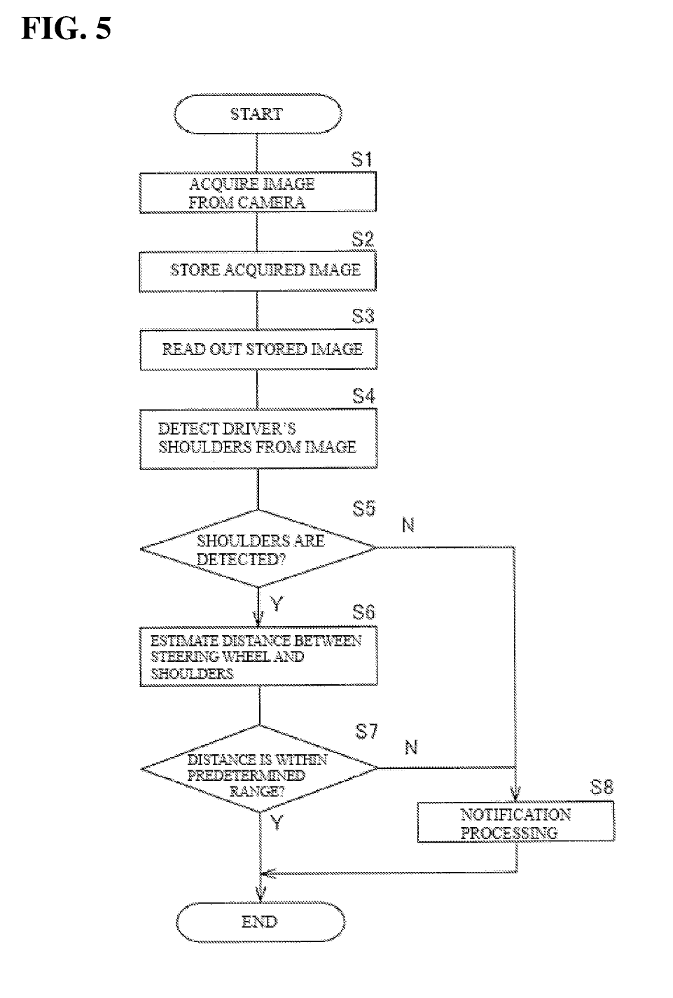

FIG. 5 is a flowchart showing a processing operation performed by the control unit 22 in the driver state recognition apparatus 20 according to an embodiment 1. Here, description will be given, assuming that the autonomous driving system 1 is set to the autonomous driving mode, that is, the vehicle is in a state of traveling under autonomous driving control. The processing operations are repeatedly performed during the period in which the autonomous driving mode is set.

First, in step S1, processing of acquiring image data of the driver captured by the camera 31 is performed. Image data may be acquired from the camera 31 one frame at a time, or multiple frames or frames over a certain time period may be collectively acquired. In the following step S2, processing for storing the acquired image data in the state recognition data storage unit 26a is performed, and then the processing moves to step S3.

In step S3, the image data stored in the state recognition data storage unit 26a is read out, and then the processing moves to step S4. The image data may be acquired one frame at a time from the state recognition data storage unit 26, or multiple frames or frames over a certain time period may be collectively acquired. In step S4, processing for detecting the shoulders of the driver from the read image data, for example, processing for detecting the position of the shoulders or the shoulder region of the driver in the image is performed, and then the processing moves to step S5.

In the processing for detecting the shoulders of the driver from the image data performed in step S4, any of the template matching method, the background difference method, and the semantic segmentation method mentioned above may be used. Or, in the case where a monocular 3D camera is included in the camera 31, information such as the detected position of each part or posture of the driver detected by the monocular 3D camera is acquired, and then the position of the shoulders of the driver may be detected using the acquired information.

If the template matching method is used, first, a template image stored in the shoulder detection method storage unit 26b, that is, one or more template images including the shoulder portions of the driver is read out. Next, the image that was read out from the state recognition data storage unit 26a undergoes processing for calculating the degree of similarity of the image of portions overlapping with the template image and detecting an area where the degree of similarity of the calculated image satisfies a certain similarity condition, while moving the template image. Then, if an area that satisfies the certain similarity condition is detected, it is determined that the shoulders are in that region, and the detection result is output.

Also, if the background difference method is used, first, the background image stored in the shoulder detection method storage unit 26b, that is, the image in which the driver is not sitting in the driver's seat is read out. Next, a difference in pixel values (background difference) for each pixel between the image read out from the state recognition data storage unit 26a and the background image is calculated. Then, from the result of the background difference calculation, processing for extracting the driver is performed. For example, the driver is extracted by binarizing the image using threshold value processing, furthermore, the position of the shoulders is detected from a characteristically shaped region (for example, an Ω-shaped portion or a gentle S-shaped portion) from the driver's head to the shoulders and arms, and the detection result is output.

If the semantic segmentation method is used, first, a learned model for shoulder detection that is stored in the shoulder detection method storage unit 26b is read out. For the learned model, a model obtained by machine learning using a large number of images, for example, in which the upper body of the driver sitting in the driver's seat (for example, a data set in which multiple classes of the driver's seat, the steering wheel, a seatbelt, and the torso, head and arms of the driver are labeled) is captured can be employed. Next, the image that was read out from the state recognition data storage unit 26a is input to the learned model. After that, a feature amount is extracted from the image, and labeling is performed for identifying the object or portion to which each pixel in that image belongs. Then, the region of the driver is segmented (divided) to extract the driver, and furthermore, the position of the shoulders of the driver (for example, the boundary between the torso and the arms) is detected based on the result of labeling each portion of the driver, and the detection result is output.

In step S5, it is determined whether the shoulders of the driver were detected. In this case, it may be determined whether the shoulders of the driver were continuously detected for a certain time period. In step S5, in a case where it is determined that the shoulders of the driver were not detected, the processing moves to step S8. The case where the shoulders of the driver were not detected includes cases where, for example, the shoulders of the driver were not captured because the driver was not in the driver's seat or the driver adopted an inappropriate posture, or cases where the state in which the driver was not detected continued for a certain time period because of some obstacle between the driver and the camera.

On the other hand, in step S5, in a case where it is determined that the shoulders of the driver were detected, the processing moves to step S6. In step S6, processing for estimating the distance between the shoulders of the driver and the steering wheel of the vehicle is performed, and then the processing moves to step S7.

In the distance estimation processing in step S6, for example, the processing method described in FIG. 4, that is, the processing for estimating through calculating the distance from the steering wheel to the shoulders of the driver, such as, for example, the distance from the right edge of the steering wheel to the right shoulder of the driver and the distance from the left edge of the steering wheel to the left shoulder of the driver, is performed based on the principle of triangulation, using the position information of driver's shoulders in the image detected in step S5, the specification and the attachment position and orientation information of the camera 31, the information of the distance between the position of the camera 31 and each portion of the steering wheel and the like, may be used. Also, if the above-mentioned TOF sensor or Kinect (registered trademark) sensor is used for the sensor 32, the data of the distance to the driver detected by the sensor 32 may be acquired, and the distance between the shoulders of the driver and the steering wheel of the vehicle may be estimated by using the distance data.

In step S7, it is determined whether the distance estimated in step S6 is in the predetermined range. The predetermined range can be set to an average range, such as, for example, a range of approximately 40 cm to 70 cm, in which the driver can immediately hold the steering wheel, taking into consideration the sex, difference in body type, normal driving posture and the like of the driver, but is not limited to this range.

Also, as the predetermined range, a distance range that has been registered in advance in the driver state recognition apparatus 20 by the driver may be used. Also, a seat surface position of the driver's seat at the time of the manual driving mode is detected, and a distance range that was set based on the seat surface position may be used. In addition, a distance range that was set based on the distance between the driver's shoulders and the steering wheel calculated using the image captured by the camera 31 at the time of the manual driving mode may be used.

In step S7, if it is determined that the estimated distance is within the predetermined range, that is, if it is determined that the driver is in the state of being able to immediately hold the steering wheel, thereafter the processing ends. Note that, in another embodiment, notification processing for notifying the driver that the driver is adopting an appropriate posture may be performed, such as, for example, providing an appropriate posture notification lamp in the display unit 62 and turning on an appropriate posture notification lamp, or outputting a signal for notifying the driver that the driver is adopting an appropriate posture, that is, that the driver is adopting an appropriate posture for continuing autonomous driving to the autonomous driving control apparatus 50.

On the other hand, in step S7, if it is determined that the estimated distance is not within the predetermined range, the processing moves to step S8. The case where the estimated distance is not within the predetermined range is a case where the distance between the steering wheel and the shoulders is too close or too far, that is, a case where the driver is in a state in which the driver cannot immediately hold the steering wheel in an appropriate posture. An appropriate posture is, for example, a posture in which the driver can hold the steering wheel with both hands.

In step S8, notification processing for prompting the driver to correct his or her posture is performed. As notification processing, processing of outputting predetermined audio from the audio output unit 61 may be performed, or processing of displaying predetermined display on the display unit 62 may be performed. The notification processing is processing for reminding the driver to adopt a posture that enables the driver to immediately hold the steering wheel if a failure or the like occurs in the autonomous driving system 1. Also, in step 8, a signal for notifying to continue autonomous driving rather than cancel autonomous driving may be output to the autonomous driving control apparatus 50.

The driver state recognition system 10 according to the above-mentioned embodiment 1 is configured to include the driver state recognition apparatus 20 and the camera 31 and/or the sensor 32 of the state recognition unit 30. Also, according to the driver state recognition apparatus 20, the shoulders of the driver are detected by the shoulder detection unit 22b from the image data captured by the camera 31, the distance between the shoulders and the steering wheel of the vehicle is estimated by the distance estimation unit 22d based on the detection information, it is determined by the determination unit 22e whether the estimated distance is within the predetermined range in which the driver can immediately hold the steering wheel of the vehicle, and thus the processing to the determination can be efficiently performed.

Furthermore, it can be accurately recognized whether the driver is adopting a posture in which the driver is able to promptly take over the operation of the steering wheel even during autonomous driving, and it is possible to appropriately provide support such that takeover manual driving from autonomous driving, particularly takeover of the operation of the steering wheel, can be performed promptly and smoothly, even if a failure or the like occurs in the autonomous driving system 1 during autonomous driving.

In addition, according to the driver state recognition apparatus 20, if it is determined by the readiness determination unit 22c that the driver is not in the state of being able to immediately hold the steering wheel of the vehicle, notification processing for prompting the driver to correct his or her posture is performed by the notification processing unit 22f. In this manner, it is possible to swiftly prompt the driver to correct his or her posture such that the driver keeps a posture that enables the driver to immediately hold the steering wheel even during autonomous driving.

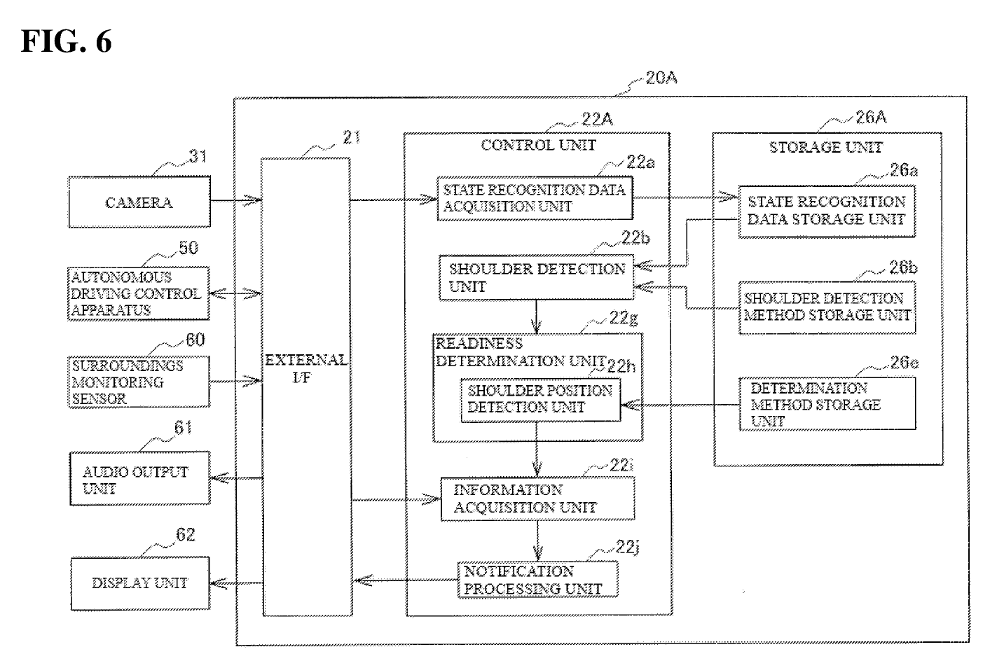

FIG. 6 is a block diagram showing an example of a hardware configuration of a driver state recognition apparatus 20A according to an embodiment 2. Note that constituent components that have the same functions as those of the driver state recognition apparatus 20 shown in FIG. 3 are assigned the same numerals, and descriptions thereof are omitted here.

The configuration in which a driver state recognition apparatus 20A according to an embodiment 2 differs from the driver state recognition apparatus 20 according to an embodiment 1 is processing executed by a readiness determination unit 22g of a control unit 22A and processing executed by a notification processing unit 22j.

The control unit 22A is configured to include the state recognition data acquisition unit 22a, the shoulder detection unit 22b, the readiness determination unit 22g, an information acquisition unit 22i, and the notification processing unit 22j. A storage unit 26A is configured to include the state recognition data storage unit 26a, the shoulder detection method storage unit 26b, and a determination method storage unit 26e.

The state recognition data storage unit 26a stores image data of the camera 31 acquired by the state recognition data acquisition unit 22a. The shoulder detection method storage unit 26b stores, for example, a shoulder detection program executed by the shoulder detection unit 22b of the control unit 22A and data necessary for executing the program.

The determination method storage unit 26e stores, for example, a determination program, which is executed by a shoulder position determination unit 22h of the control unit 22A, for determining whether the driver is in the state of being able to immediately hold the steering wheel and data necessary for executing the program. For example, shoulder position determination region data for determining whether the driver is in the state of being able to immediately hold the steering wheel and the like is stored.

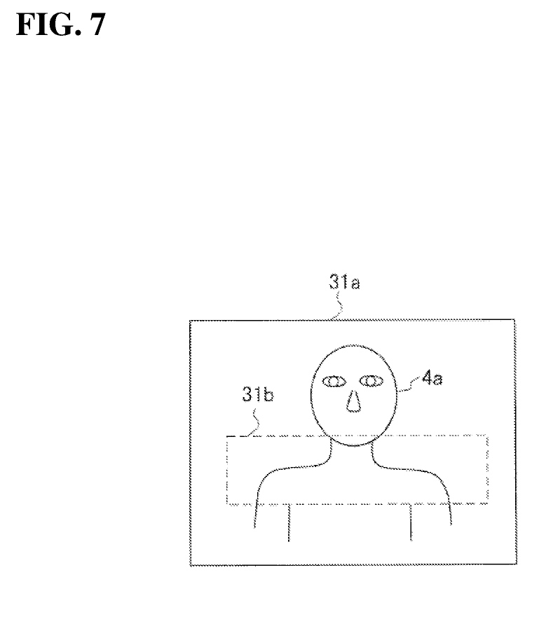

FIG. 7 is a block diagram illustrating an example of the shoulder position determination region data stored in the determination method storage unit 26e.

In the case where the driver goes to hold the steering wheel of the vehicle with an appropriate posture, the driver will be substantially facing the steering wheel. Thus, in the state of being able to immediately hold the steering wheel of the vehicle, the shoulders of the driver 4a in the image 31a will be positioned in a certain region in the image. The certain region in the image is set as a shoulder position determination region 31b. The shoulder position determination region 31b can be determined based on a predetermined normal driving posture. A configuration is adopted in which it can be determine whether the driver is in the state of being able to immediately hold the steering wheel of the vehicle, depending on whether the position of the shoulders of the driver 4a in the image detected by the shoulder detection unit 22b are located within the shoulder position determination region 31b.

The shoulder position determination region 31b may be a region that is set in advance based on the positions of the shoulders of drivers of different sexes and body types in multiple images captured in the state in which the drivers are holding the steering wheel. Also, a configuration may be adopted in which the position of the shoulders of a driver is detected from an image of the driver captured during the manual driving mode, and the shoulder position determination region 31b is set for each driver based on the detected position of the shoulders. Also, the shoulder position determination region 31b may be configured by two regions of a right shoulder region and a left shoulder region. Note that it is preferable to employ a fixed focus camera for the camera 31.

The state recognition data acquisition unit 22a that configures the control unit 22A performs processing for acquiring the image data of the driver captured by the camera 31, and performs processing for storing the acquired image data in the state recognition data storage unit 26a.

The shoulder detection unit 22b reads out the image data from the state recognition data storage unit 26a, performs image processing with respect to the image data based on the program that was read out from the shoulder detection method storage unit 26b, and performs processing for detecting the shoulders of the driver in the image. For example, through the image processing, it is possible to extract edges from the driver's head to the shoulders and arms, and to detect a portion of the shoulder portion having a characteristic shape, such as, for example, an Q shape or a gentle S shape, as the shoulder.

The readiness determination unit 22g includes the shoulder position determination unit 22h. Following the processing by the shoulder detection unit 22b, the shoulder position determination unit 22h performs, based on the detection information of the shoulder detection unit 22b and the shoulder position determination region data that was read out from the determination method storage unit 26e, processing for determining whether the position of the shoulders of the driver in the image are located within the shoulder position determination region. Through the determination processing, it is determined whether the driver is in the state of being able to immediately hold the steering wheel.

The information acquisition unit 22i acquires information arising during autonomous driving from the units of the autonomous driving system 1. The information arising during autonomous driving includes at least one of vehicle-surroundings monitoring information that is detected by the surroundings monitoring sensor 60 and takeover request information for taking over manual driving from autonomous driving that is sent from the autonomous driving control apparatus 50. The vehicle-surroundings monitoring information may be, for example, information notifying that the vehicle is being rapidly approached by another vehicle, or may be information indicating that the vehicle will travel on a road where the functional limit of the system is envisioned, such as a narrow road with sharp curves. Also, the takeover request information for taking over manual driving from autonomous driving may be, for example, information indicating that the vehicle has entered a takeover zone in which to take over manual driving from autonomous driving or may be information notifying that an abnormality or failure has occurred in a part of the autonomous driving system 1.

If it is determined that by the readiness determination unit 22g the driver is not in the state of being able to immediately hold the steering wheel, the notification processing unit 22j performs notification processing for prompting the driver to correct his or her posture according to the information arising during autonomous driving that is acquired by the information acquisition unit 22i. For example, the notification processing unit 22j performs processing for causing the audio output unit 61 and the display unit 62 to perform output processing of audio and output processing of display for prompting the driver to adopt a posture that enables the driver to immediately hold the steering wheel. Note that, in another embodiment, a configuration may be adopted in which, instead of the information acquisition unit 22i and the notification processing unit 22j, the notification processing unit 22f described in the above embodiment 1 is provided in the control unit 22A is provided. Also, the notification processing unit 22j may output a signal notifying to continue autonomous driving rather than cancel autonomous driving to the autonomous driving control apparatus 50.

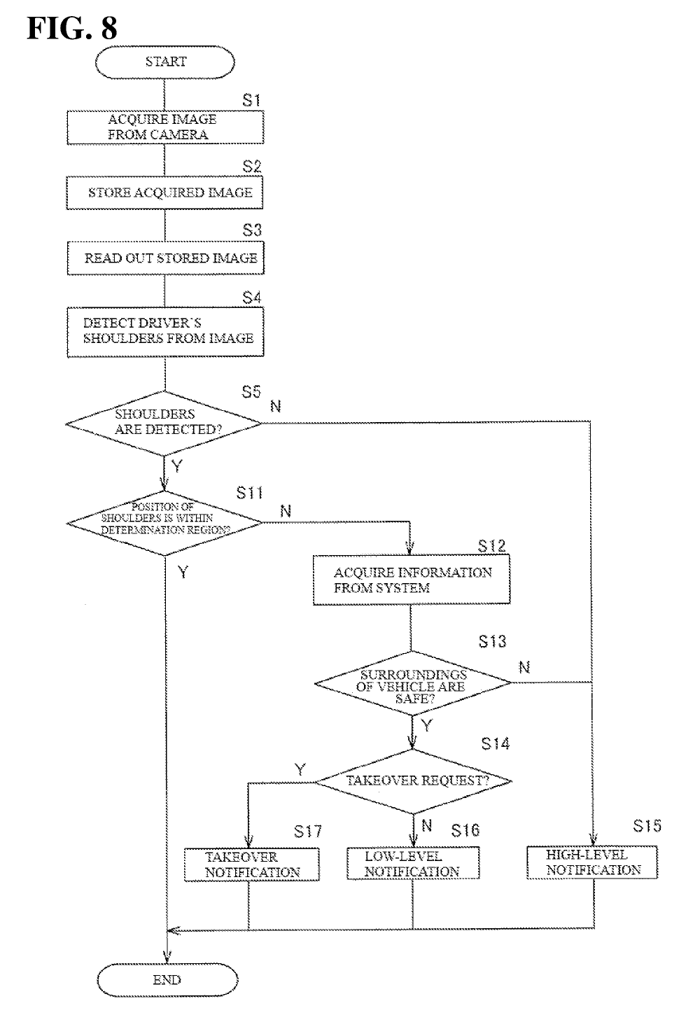

FIG. 8 is a flowchart showing a processing operation performed by a control unit 22A in the driver state recognition apparatus 20A according to an embodiment 2. Processing operations that have the same content as those of the flowchart shown in FIG. 5 are assigned the same numerals.

First, in step S1, processing of acquiring image data of the driver captured by the camera 31 is performed, and then the processing moves to step S2, where processing for storing the acquired image data in the state recognition data storage unit 26a is performed. In the following step S3, the image data stored in the state recognition data storage unit 26a is read out, and then the processing moves to step S4.

In step S4, processing for detecting the shoulders of the driver from the read image data is performed, and then the processing moves to step S5. In the processing for detecting the shoulders of the driver from the image data that is executed in step S4, any of the template matching method, the background difference method, and the semantic segmentation method mentioned above may be used. In addition, in the case where a monocular 3D camera is included in the camera 31, information such as the detected position of each part or posture of the driver detected by the monocular 3D camera is acquired, and then the position of the shoulders of the driver may be detected using the acquired information.

In step S5, it is determined whether the shoulders of the driver were detected. In this case, it may be determined whether the shoulders of the driver were continuously detected for a certain time period. In step S5, if it is determined that the shoulders of the driver were not detected, the processing moves to step S15 in which a high-level notification processing is performed, whereas if it is determined that the shoulders of the driver were detected, the processing moves to step S11.

In step S11, the shoulder position determination region data and the like are read out from the determination method storage unit 26e, and it is determined whether the shoulder positions of the driver in the image detected in step S5 are within the shoulder position determination region 31b.

In step S11, if it is determined that the position of the shoulders of the driver in the image are within the shoulder position determination region 31b, that is, if it is determined that the driver is in the state of being able to immediately hold the steering wheel, and thereafter the processing ends. Note that, in another embodiment, notification processing for notifying the driver that the driver is adopting an appropriate posture may be performed, such as, for example, by providing an appropriate posture notification lamp in the display unit 62 and turning on an appropriate posture notification lamp, or outputting a signal for notifying the driver that the driver is adopting an appropriate posture, that is, that the driver is taking an appropriate posture for continuing autonomous driving to the autonomous driving control apparatus 50.

On the other hand, in step S11, if it is determined that the position of the shoulders of the driver in the image are not within the shoulder position determination region 31b, the processing moves to step S12. Information is acquired from the autonomous driving system 1 in step S12, and then the processing moves to step S13. The information includes the vehicle-surroundings monitoring information that was detected by the surroundings monitoring sensor 60 and the takeover request information for taking over manual driving from autonomous driving that is output from the autonomous driving control apparatus 50. The takeover request information includes, for example, a system abnormality (failure) occurrence signal, a system functional limit signal, or an entry signal indicating entry to a takeover zone.

In step S13, based on the vehicle-surroundings monitoring information that was acquired from the surroundings monitoring sensor 60, it is determined whether the surroundings of the vehicle are in a safe state. In step S13, if it is determined that the surroundings of the vehicle are not in a safe state, such as, for example, if it is determined that information indicating that another vehicle, a person, or other obstacle is detected in a certain range of the surroundings of the vehicle (any of forward, lateral, and backward), information notifying that another vehicle is rapidly approaching, or information indicating that the vehicle will travel on a road where the functional limit of the system is envisioned, such a narrow road with sharp curves was acquired, and then the processing moves to the high-level notification processing in step S15. In step S15, the high-level notification processing is performed for causing the driver to swiftly adopt a posture that enables the driver to immediately hold the steering wheel, and then the processing ends. In the high-level notification processing, it is preferable that notification is performed in which display and audio are combined. Notification other than display or audio, such as, for example, applying vibrations to the driver's seat or the like may be added. Also, in step S15, a signal for notifying to continue the autonomous driving rather than cancel the autonomous driving may be output to the autonomous driving control apparatus 50.

On the other hand, in step S13, if it is determined that the surroundings of the vehicle are in a safe state, the process moves to step S14. In step S14, it is determined whether takeover request information for taking over manual driving has been acquired from the autonomous driving control apparatus 50, that is, it is determined whether there is a takeover request.

In step S14, if it is determined that there is no takeover request, the processing moves to a low-level notification processing in step S16. In step S16, the low-level notification processing is performed such that the driver adopts the posture that enables the driver to hold the steering wheel, and then the processing ends. In the low-level notification processing, it is preferable to gently notify the driver, such as notification through display only, in order to achieve harmony between the autonomous driving and the driver.

On the other hand, in step S14, if it is determined that there is a takeover request, the process moves to step S17. In step S17, a takeover notification is performed by audio or display such that the driver immediately holds the steering wheel and takes over the driving, and then the processing ends.

In the driver state recognition apparatus 20A according to the above embodiment 2, the shoulders of the driver are detected by the shoulder detection unit 22b from the image data captured by the camera 31, it is determined whether the driver is in the state of being able to immediately hold the steering wheel during autonomous driving by determining whether the position of the shoulders of the driver in the image is within the shoulder position determination region 31b, and thus processing until the determination can be efficiently executed.

Furthermore, it can be accurately recognized whether the driver is adopting a posture for promptly taking over the operation of the steering wheel even during autonomous driving, and it is possible to appropriately provide support such that takeover of manual driving from autonomous driving is performed promptly and smoothly, even in cases such as where a failure occurs in the autonomous driving system 1 during autonomous driving.

Also, according to the driver state recognition apparatus 20A, the notification processing unit 22j performs notification processing for prompting the driver to correct his or her posture according to the information arising during autonomous driving that is acquired by the information acquisition unit 22i. For example, if vehicle-surroundings monitoring information that indicates that the surroundings of the vehicle are not in a safe state is acquired, the level of the notification processing performed by the notification processing unit 22j can be raised to more strongly alert the driver through the high-level notification to adopt a posture in which the driver can immediately take over the operation of the steering wheel. Also, if the surroundings of the vehicle are safe, and there is no takeover request, it is possible to gently prompt the driver to correct his or her posture through the low-level notification. On the other hand, if there is a takeover request, it is possible to notify the driver so as to adopt a posture for taking over. In this manner, it is not required to needlessly perform various notifications to the driver, according to the situation of the autonomous driving system 1, and thus power and processing required for the notification can be reduced.

Also, at the time of failure occurrence or an operating limit of the system, or at the time of a request for taking over manual driving, the time period until the driver holds the steering wheel and takeover of the driving operation is completed can be shortened, and thus it is possible to make an appropriate notification that is gentle on the driver, according to the state of the autonomous driving system 1.

Note that, in the above driver state recognition apparatus 20 according to an embodiment 1, the information acquisition unit 22i and the notification processing unit 22j may be provided instead of the notification processing unit 22f, and instead of step S8 shown in FIG. 5, similar processing to steps S12 to s17 shown in FIG. 8, that is, notification processing for prompting the driver to correct his or her posture may be performed according to information arising during autonomous driving that is acquired by the information acquisition unit 22i.

1. A driver state recognition apparatus for recognizing a state of a driver of a vehicle provided with an autonomous driving system, comprising:
a state recognition data acquisition unit configured to acquire state recognition data of an upper body of the driver;
a shoulder detection unit configured to detect a shoulder of the driver using the state recognition data acquired by the state recognition data acquisition unit; and
a readiness determination unit configured to determine, based on detection information from the shoulder detection unit, whether the driver is in a state of being able to immediately hold a steering wheel of the vehicle during autonomous driving.

2. The driver state recognition apparatus according to claim 1,
wherein the state of being able to immediately hold the steering wheel of the vehicle is determined based on a predetermined normal driving posture.

3. The driver state recognition apparatus according to claim 1,
wherein the readiness determination unit includes:
a distance estimation unit configured to estimate a distance between the shoulder of the driver and the steering wheel of the vehicle, based on the detection information from the shoulder detection unit, and
the readiness determination unit determines whether the driver is in the state of being able to immediately hold the steering wheel of the vehicle based on the distance estimated by the distance estimation unit.

4. The driver state recognition apparatus according to claim 3,
wherein the state recognition data includes image data of the upper body of the driver captured by a camera provided in the vehicle, and
the distance estimation unit performs the estimation by calculating the distance based on a principle of triangulation, using information including a position of the shoulder of the driver in the image detected by the shoulder detection unit and a specification and a position and orientation of the camera.

5. The driver state recognition apparatus according to claim 4,
wherein, in a case where an origin provided on the steering wheel of the vehicle is at a vertex of a right angle of a right angle triangle whose hypotenuse is a line segment connecting the camera and the shoulder of the driver,
the specification of the camera includes information of an angle of view a and a pixel number Width in a width direction of the camera,
the position and orientation of the camera include information of an attachment angle θ of the camera and a distance D1 from the camera to the origin, and
the position of the shoulder of the driver in the image is given as X, the distance estimation unit calculates an angle φ formed by a line segment connecting the origin and the shoulder of the driver and the line segment connecting the camera and the shoulder of the driver with an equation 1: φ=θ+α/2−α×X/Width, and
performs the estimation by calculating a distance D between the shoulder of the driver and the steering wheel of the vehicle with an equation 2: D=D1/tan φ.

6. The driver state recognition apparatus according to claim 1,
wherein the readiness determination unit estimates a position of the shoulder of the driver based on the detection information from the shoulder detection unit, and determines whether the driver is in the state of being able to immediately hold the steering wheel of the vehicle based on the estimated position of the shoulder of the driver.

7. The driver state recognition apparatus according to claim 1, further comprising:
a notification processing unit configured to perform notification processing for prompting the driver to correct a posture, if the readiness determination unit determines that the driver is not in the state of being able to immediately hold the steering wheel of the vehicle.

8. The driver state recognition apparatus according to claim 7, further comprising:
an information acquisition unit configured to acquire information arising during autonomous driving from the autonomous driving system,
wherein the notification processing unit performs the notification processing for prompting the driver to correct the posture according to the information arising during autonomous driving that is acquired by the information acquisition unit.

9. The driver state recognition apparatus according to claim 8,
wherein the information arising during autonomous driving includes at least one of monitoring information of surroundings of the vehicle and takeover request information for taking over manual driving from autonomous driving.

10. A driver state recognition system comprising:
the driver state recognition apparatus according to claim 1; and
a state recognition unit configured to output the state recognition data to the driver state recognition apparatus.

11. The driver state recognition apparatus according to claim 2,
wherein the readiness determination unit includes:
a distance estimation unit configured to estimate a distance between the shoulder of the driver and the steering wheel of the vehicle, based on the detection information from the shoulder detection unit, and
the readiness determination unit determines whether the driver is in the state of being able to immediately hold the steering wheel of the vehicle based on the distance estimated by the distance estimation unit.

12. The driver state recognition apparatus according to claim 11,
wherein the state recognition data includes image data of the upper body of the driver captured by a camera provided in the vehicle, and
the distance estimation unit performs the estimation by calculating the distance based on a principle of triangulation, using information including a position of the shoulder of the driver in the image detected by the shoulder detection unit and a specification and a position and orientation of the camera.

13. The driver state recognition apparatus according to claim 12,
wherein, in a case where an origin provided on the steering wheel of the vehicle is at a vertex of a right angle of a right angle triangle whose hypotenuse is a line segment connecting the camera and the shoulder of the driver,
the specification of the camera includes information of an angle of view a and a pixel number Width in a width direction of the camera,
the position and orientation of the camera include information of an attachment angle θ of the camera and a distance D1 from the camera to the origin, and
the position of the shoulder of the driver in the image is given as X,
the distance estimation unit calculates an angle φ formed by a line segment connecting the origin and the shoulder of the driver and the line segment connecting the camera and the shoulder of the driver with an equation 1: φ=θ+α/2−α×X/Width, and
performs the estimation by calculating a distance D between the shoulder of the driver and the steering wheel of the vehicle with an equation 2: D=D1/tan φ.

14. The driver state recognition apparatus according to claim 2,
wherein the readiness determination unit estimates a position of the shoulder of the driver based on the detection information from the shoulder detection unit, and determines whether the driver is in the state of being able to immediately hold the steering wheel of the vehicle based on the estimated position of the shoulder of the driver.

15. The driver state recognition apparatus according to claim 2, further comprising:
a notification processing unit configured to perform notification processing for prompting the driver to correct a posture, if the readiness determination unit determines that the driver is not in the state of being able to immediately hold the steering wheel of the vehicle.

16. The driver state recognition apparatus according to claim 15, further comprising:
an information acquisition unit configured to acquire information arising during autonomous driving from the autonomous driving system,
wherein the notification processing unit performs the notification processing for prompting the driver to correct the posture according to the information arising during autonomous driving that is acquired by the information acquisition unit.

17. The driver state recognition apparatus according to claim 16,
wherein the information arising during autonomous driving includes at least one of monitoring information of surroundings of the vehicle and takeover request information for taking over manual driving from autonomous driving.

18. A driver state recognition method for recognizing a state of a driver of a vehicle provided with an autonomous driving system, comprising:
acquiring state recognition data of an upper body of the driver from a state recognition unit configured to recognize a state of the driver;
storing the acquired state recognition data in a state recognition data storage unit;
reading out the state recognition data from the state recognition data storage unit;
detecting a shoulder of the driver using the read state recognition data; and
determining, based on detection information of the detected shoulder of the driver, whether the driver is in a state of being able to immediately hold a steering wheel of the vehicle during autonomous driving.
